(19) United States
(12) Patent Application Publication
(10) Pub. No.: US 2006/0268320 A1
(43) Pub. Date: Nov. 30, 2006

(54) Method for handling confidential jobs in an imaging apparatus

(75) Inventors: Amanda Kay Bridges, Winchester, KY (US); William James Gardner Flowers, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/138,628

(22) Filed: May 26, 2005

(51) Int. Cl. G06F 3/12

(52) U.S. Cl. 358/1.15

(57) ABSTRACT

A method for handling jobs in an imaging apparatus includes setting in the imaging apparatus an expiration time at which a job designated as confidential will be deleted from the processing queue of the imaging apparatus; storing in a container of an object store job identity information relating to each pending job associated with a designated user of the container; automatically deleting a confidential job of the pending jobs from the processing queue without human intervention when the expiration time for the confidential job is reached; and storing in the container metadata for notifying the user of the deleting of the confidential job.

### BACKGROUND OF THE INVENTION

1. Field of the Invention

The present invention relates to an imaging apparatus, and, more particularly, to a method for handling confidential jobs in an imaging apparatus.

2. Description of the Related Art

Typical networked computer systems permit multiple users operating individual workstations to share printing resources. In such systems, individual workstations may be at some distance from the printer that will output the printed copies. Thus, a user may not be present when the job that the user submitted is printed. Even a user who is stationed near such a printer may not be aware that the job is being printed, since print jobs are typically stored in a printer queue and will be printed in the order in which they are submitted to the printer.

In situations where many users share a printer, or where jobs are large or slow to process, as in the case of processing graphical images, there may be a considerable time delay between submitting a job and it being printed. Thus, it is possible that a private print job may be removed and subject to scrutiny by a person other than the one who submitted the job for printing, resulting in a breach of private information. For example, confidential personnel records concerning medical conditions, employee benefits and/or salary information may be printed out and used for improper purposes. Furthermore, the longer the private print job stays in the printing queue, the more likely the private print job will be intercepted by an unauthorized person.

### SUMMARY OF THE INVENTION

The present invention provides a method for handling jobs, such as for example confidential print jobs, in an imaging apparatus including a memory forming a processing queue for storing pending jobs and forming an object store having a plurality of containers, each container being assigned to at least one corresponding user.

The present invention, in one exemplary embodiment, includes setting in the imaging apparatus an expiration time at which a job designated as confidential will be deleted from the processing queue of the imaging apparatus; storing in a container job identity information relating to each pending job associated with a designated user of the container; automatically deleting a confidential job of the pending jobs from the processing queue without human intervention when the expiration time for the confidential job is reached; and storing in the container metadata for notifying the user of the deleting of the confidential job.

The present invention, in another exemplary embodiment, is directed to setting in the imaging apparatus an expiration time at which a job designated as confidential will be deleted from the processing queue of the imaging apparatus; storing in a container job identity information relating to each pending job associated with a designated user of the container; storing in the container metadata for notifying the user of an upcoming deleting of a confidential job of the pending jobs; generating, based on the metadata, a notification message relating to the upcoming deleting of the confidential job; and sending the notification message to the designated user.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic representation of a system embodying the present invention.

FIGS. 2A and 2B combine to form a flowchart of a method for handling jobs in the imaging apparatus of the system of FIG. 1, in accordance with the present feature.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

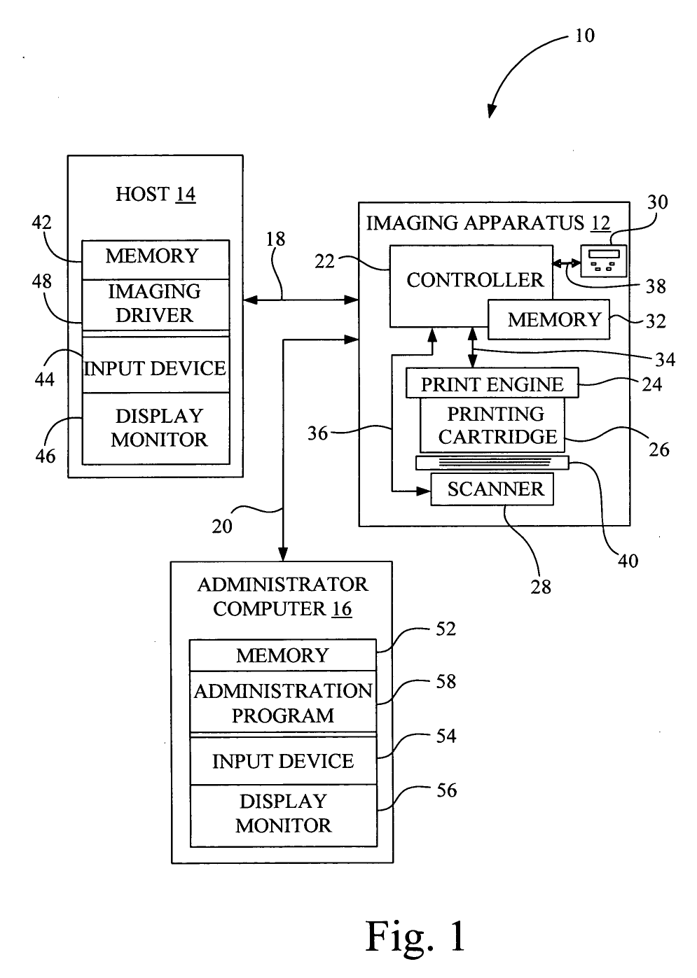

Referring now to the drawings, and particularly to FIG. 1, there is shown a diagrammatic depiction of an imaging system 10 embodying the present invention. Imaging system 10 includes an imaging apparatus 12, a host 14, and an administrator computer 16.

Host 14 is communicatively coupled to imaging apparatus 12 via a communications link 18. Administrator computer 16 is communicatively coupled to imaging apparatus 12 via a communications link 20.

As used herein, the term “communications link” generally refers to structure that facilitates electronic communication between two or more components, and may operate using wired or wireless technology. Accordingly, communications link 18 and communications link 20 may be, for example, a direct electrical wired connection, a direct wireless connection (e.g., infrared or r.f.), or a network connection (wired or wireless), such as for example, an Ethernet local area network (LAN) or a wireless networking standard, such as IEEE 802.11. In a network environment, communications links 18 and 20 may be a part of the same network, or may be a part of different networks that are communicatively linked.

Imaging apparatus 12 may be, for example, a printer, such as an ink jet printer or electrophotographic printer, or a multi-function printer (MFP), such as for example, a standalone unit that has scanning, copying, and/or faxing functionality, in addition to printing functionality. In the embodiment shown in FIG. 1, imaging apparatus 12 is an MFP, and includes a controller 22, a print engine 24, a printing cartridge 26, a scanner 28, and a user interface 30.

Controller 22 includes a processor unit and associated memory 32, and may be formed as one or more Application Specific Integrated Circuits (ASICs). In the present embodiment, controller 22 functions as both a printer controller and a scanner controller. Controller 22 is communicatively coupled to print engine 24 via a communications link 34, is communicatively coupled to scanner 28 via a communications link 36, and is communicatively coupled to user interface 30 via a communications link 38. Controller 22 serves to process print data and to operate print engine 24 during printing, and serves to operate and process data from scanner 28 during a scanning operation.

In the context of the examples for imaging apparatus 12 given above, print engine 24 may be, for example, an ink jet print engine or a color electrophotographic print engine. Print engine 24 is configured to mount printing cartridge 26 and to print on a sheet of print media 40, such as a sheet of plain paper, fabric, photo paper, coated ink jet paper, greeting card stock, transparency stock, etc. As an ink jet print engine, print engine 24 operates printing cartridge 26 to eject ink droplets onto the sheet of print media 40 in order to reproduce text or images, etc. As an electrophotographic print engine, print engine 24 causes printing cartridge 26 to deposit toner onto the sheet of print media 40, which is then fused to the sheet of print media 40 by a fuser (not shown).

Host 14 may be, for example, a personal computer, including a memory 42, an input device 44, such as a keyboard, and a display monitor 46. Memory 42 may be, for example, one or more of semiconductor memory, such as random access memory (RAM), read only memory (ROM), and non-volatile RAM (NVRAM), and a mass data storage device, such as a hard drive, a CD-ROM and/or a DVD. Host 14 further includes a processor and appropriate input/output (I/O) interfaces (not shown).

During operation, host 14 includes in its memory a software program including program instructions, which when executed functions as an imaging driver 48, e.g., printer/scanner driver software, for imaging apparatus 12. Imaging driver 48 is in communication with controller 22 of imaging apparatus 12 via communications link 18. Imaging driver 48 facilitates communication between imaging apparatus 12 and host 14, and may provide formatted print data to imaging apparatus 12, and more particularly, to print engine 24. Although imaging driver 48 is disclosed as residing in memory 42 of host 14, it is contemplated that, alternatively, all or a portion of imaging driver 48 may be located in controller 22 and/or memory 32 of imaging apparatus 12.

Administrator computer 16 may be, for example, a personal computer, including a memory 52, an input device 54, such as a keyboard, and a display monitor 56. Memory 52 may be, for example, one or more of semiconductor memory, such as random access memory (RAM), read only memory (ROM), non-volatile RAM (NVRAM), and a mass data storage device, such as a hard drive, a CD-ROM and/or a DVD. Administrator computer 16 further includes a processor and appropriate input/output (I/O) interfaces (not shown). During operation, administrator computer 16 executes an administration program 58 (i.e., software and/or firmware) that is used, for example, to configure devices to which it is communicatively coupled, such as imaging apparatus 12. Administration program 58 is in communications with controller 22 of imaging apparatus 12 via communication link 20.

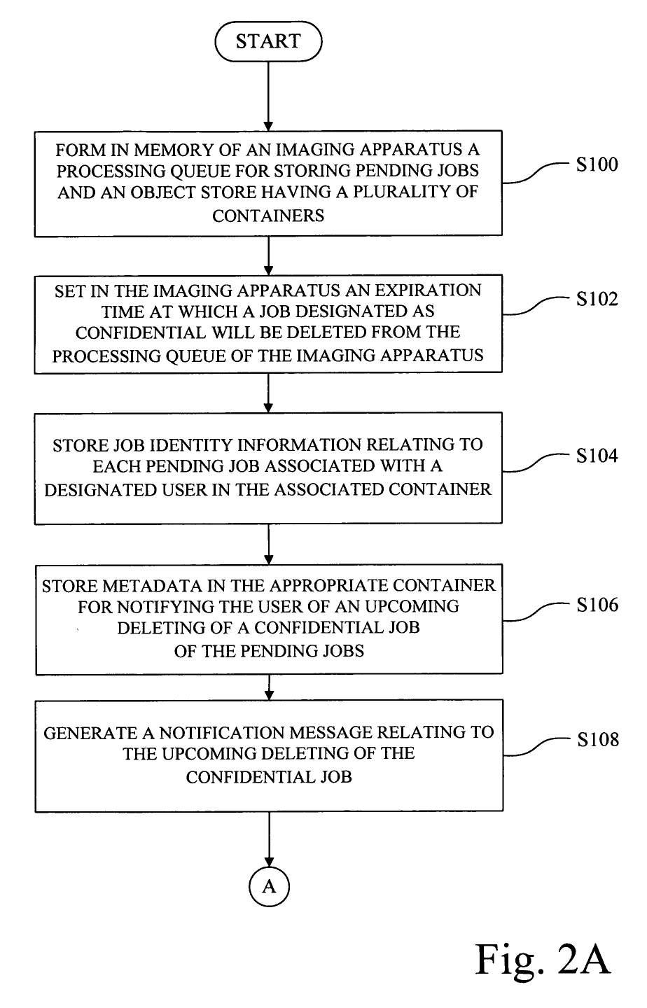

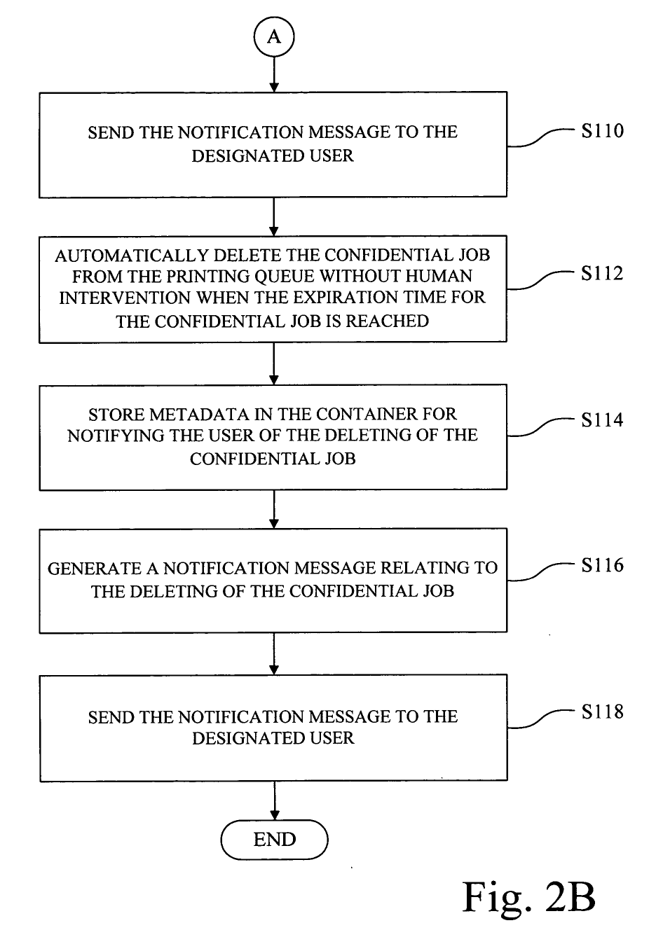

FIGS. 2A and 2B combine to form a flowchart of a method for handling jobs in imaging apparatus 12, and more particularly, a method for handling confidential jobs, such as confidential print jobs. The order of the steps as set forth below was selected merely for convenience to aid the reader in understanding the present invention. Those skilled in the art will recognize that the order of some of the steps may be varied without departing from the principles of the present invention.

At step S100, a processing queue, e.g., a printing queue, for storing pending jobs and an object store having a plurality of containers are formed in memory 32 of imaging apparatus 12. In order to facilitate the tracking of confidential jobs and associate the confidential jobs with an individual user of a plurality of possible users of imaging apparatus 12, the object store is formed in memory 32 of imaging apparatus 12. The object store includes a plurality of containers, each container being assigned to at least one corresponding designated user. Each user has a personal identification number (PIN) that is used to access a particular container in the object store. Within each container will be stored job identity information relating to each pending job associated with a designated user of the container, including confidential jobs. Accordingly, with the appropriate PIN, a designated user can access the corresponding container, and in turn, can manually deleted any job, including confidential jobs, via user interface 30, or through host 14 via imaging driver 48.

In order to process confidential jobs with imaging apparatus 12 in a normal manner, the user must be physically present at imaging apparatus 12 and provide the user's PIN and a command via user interface 30 to imaging apparatus 12 to begin the processing. For example, in order to print a confidential print job with imaging apparatus 12, the confidential print job must be present in the printer queue established in memory 32 of imaging apparatus 12. In addition, the user must supply the appropriate user PIN to imaging apparatus 12 to release the confidential print job for printing. In such normal processing of the confidential print job, the confidential print job is deleted by controller 22 following the printing of the confidential print job.

At step S102, an expiration time at which a job designated as confidential will be deleted from the processing queue of the imaging apparatus is set in imaging apparatus 12.

The present invention facilitates the setting of the machine default in imaging apparatus 12 for a confidential job by a system administrator via the configuration menus for imaging apparatus 12, i.e., the MFP, so as to delete the confidential print job after a predetermined period of time. For example, a system administrator operating administrator computer 16 that is executing administration program 58 can access the configuration menus for imaging apparatus 12 in imaging apparatus 12, and set the machine configuration settings in accordance with the system protocols.

As an example, by accessing a confidential print job expiration setting for a confidential print job, the system administrator may set an expiration time limit for the confidential print job, so that in the absence of a release of the confidential print job to print prior to the expiration time being reached, the confidential print job will not remain indefinitely in the printing queue. The choices for this setting may include, for example, OFF, 1 hour, 4 hours, 8 hours, 24 hours, 1 week, etc. When the confidential print job expiration setting is set to anything except OFF, the confidential print job will be deleted automatically at the indicated expiration time. Or, if imaging apparatus 12 happens to be turned off at the expiration time, the confidential print job will be deleted automatically at the next power up after the specified expiration time.

Optionally, the setting of the machine default for a confidential job via the configuration menus for imaging apparatus 12 may be also available to the user of imaging apparatus 12 through the imaging driver 48 of host 14 on a “per-job” basis, and the “per-job” application of the setting from imaging driver 48 will override the machine default implementation. A setting may be provided that limits the user's ability to change the machine default for a confidential job, or to eliminate that ability all together if desired, thereby forcing the machine default for the confidential job to be the only value used for the confidential print job expiration setting.

At step S104, job identity information relating to each pending job associated with a designated user is stored in the associated container. The object store keeps track of all the user names and PIN combinations, and all the held pending jobs, including confidential jobs.

At step S106, metadata for notifying the user of an upcoming deleting of a confidential job of the pending jobs is stored in the appropriate container. The metadata may include, for example, an identification of the device, e.g., host, or other computer or device, to which a notification is to be sent. Alternatively, the metadata may include an email address to which the notification is to be sent.

At step S108, a notification message relating to the upcoming deleting of the confidential job is generated.

At step S110, the notification message is sent to the designated user.

For example, the next time the container is accessed by the designated user, the notification message may be generated and displayed at user interface 30 of imaging apparatus 12 and/or on display monitor 46 of host 14.

Alternatively, where the metadata includes an email address, the notification message relating to the upcoming deleting of the confidential job is generated and sent to the designated email address.

Provisions are made so that if the user responds to the notification message, the expiration time may be reset, e.g., extended, to allow more time for a busy user to initiate the printing of the user's confidential job.

At step S112, the confidential job is automatically deleted from the printing queue without human intervention when the expiration time for the confidential job is reached.

At step S114, metadata is stored in the container for notifying the user of the deleting of the confidential job. The metadata may include, for example, an identification of the device, e.g., host, or other computer or device, to which a notification is to be sent. Alternatively, the said metadata may include an email address to which the notification is to be sent.

At step S116, a notification message relating to the deleting of the confidential job is generated.

At step S118, the notification message is sent to the designated user.

For example, the next time the container is accessed by the designated user, a notification message may be generated and displayed at user interface 30 of imaging apparatus 12 and/or on display monitor 46 of host 14 indicating the deleting of the confidential job. Alternatively, where the metadata includes an email address, the notification message relating to the deleting of the confidential job is generated and sent to the designated email address.

After acknowledging the notification message, or after a message time out, the normal held job work flow associated with the user's container may resume for the jobs in the processing queue that have not yet expired.

While this invention has been described with respect to embodiments of the invention, it is to be understood that the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for handling jobs in an imaging apparatus including a memory forming a processing queue for storing pending jobs and forming an object store having a plurality of containers, each container being assigned to at least one corresponding user, the method comprising:
setting in said imaging apparatus an expiration time at which a job designated as confidential will be deleted from said processing queue of said imaging apparatus;
storing in a container job identity information relating to each pending job associated with a designated user of said container;
automatically deleting a confidential job of said pending jobs from said processing queue without human intervention when said expiration time for said confidential job is reached; and
storing in said container metadata for notifying said user of said deleting of said confidential job.

2. The method of claim 1, wherein the setting of said expiration time is via a configuration menu for said imaging apparatus.

3. The method of claim 2, wherein access to said configuration menu is restricted to an administrator.

4. The method of claim 2, wherein said configuration menu is accessed via an imaging driver program running on a computer.

5. The method of claim 1, wherein said metadata is used to generate a notification message relating to said deleting of said confidential job for display at a device designated to receive said notifying.

6. The method of claim 1, wherein said metadata includes a computer identification, and wherein a notification message is sent to a computer corresponding to said computer identification for display on a display monitor.

7. The method of claim 1, wherein said metadata includes an email address, and further comprising:
generating a notification message relating to said deleting of said confidential job; and
sending said notification message to said email address.

8. A method for handling jobs in an imaging apparatus including a memory forming a processing queue for storing pending jobs and forming an object store having a plurality of containers, each container being assigned to at least one corresponding user, the method comprising:
setting in said imaging apparatus an expiration time at which a job designated as confidential will be deleted from said processing queue of said imaging apparatus;
storing in a container job identity information relating to each pending job associated with a designated user of said container;
storing in said container metadata for notifying said user of an upcoming deleting of a confidential job of said pending jobs;
generating, based on said metadata, a notification message relating to said upcoming deleting of said confidential job; and
sending said notification message to said designated user.

9. The method of claim 8, further comprising automatically deleting said confidential job from said processing queue without human intervention when said expiration time for said confidential job is reached.

10. The method of claim 8, wherein said metadata includes a computer identification, and wherein said notification message is sent to a computer corresponding to said computer identification for display on a monitor.

11. The method of claim 8, wherein said metadata includes an email address, and wherein said notification message is sent to said email address.

12. The method of claim 8, wherein when said designated user responds to said notification message, said expiration time is reset.

13. The method of claim 8, wherein the setting of said expiration time is via a configuration menu for said imaging apparatus.

14. The method of claim 13, wherein access to said configuration menu is restricted to an administrator.

15. The method of claim 13, wherein said configuration menu is accessed via an imaging driver program running on a computer.
